(19) United States
(12) Patent Application Publication
(10) Pub. No.: US 2019/0345355 A1
(43) Pub. Date: Nov. 14, 2019

(54) INK COMPOSITIONS

(71) Applicant: Hewlett-Packard Development Company , L.P., Spring, TX (US)

(72) Inventors: Natalie HARVEY, Corvallis, OR (US); Thomas W. BUTLER, Corvallis, OR (US); Vladimir JAKUBEK, Corvallis, OR (US)

(73) Assignee: Hewlett-Packard Development Company , L.P., Spring, TX (US)

(21) Appl. No.: 16/463,081

(22) PCT Filed: Apr. 25, 2017
(86) PCT No.: PCT/US2017/029270

§ 371 Date: May 22, 2019

(51) Int. Cl. C09D 11/324; C09D 11/38; C09D 11/102; C09D 11/033; C09D 11/037; B41M 5/00

(52) U.S. Cl. CPC C09D 11/324; C09D 11/38; B41M 5/0023; C09D 11/033; C09D 11/037; C09D 11/102

(57) ABSTRACT

The present disclosure is drawn to an ink composition. The ink composition can include carbon black pigment, polyurethane, at least 50 wt % water, and from 1 wt % to 6 wt % of diol solvent, triol solvent, or a mixture thereof. When the solvent is a diol solvent the ink composition can be devoid of 2-pyrrolidone.

### BACKGROUND

Inkjet printing has become a popular way of recording images on various media. Some of the reasons include low printer noise, variable content recording, capability of high speed recording, and multi-color recording. These advantages can be obtained at a relatively low price to consumers. As the popularity of inkjet printing increases, the types of use also increase providing demand for new ink compositions.

### BRIEF DESCRIPTION OF THE DRAWINGS

FIG. 1 graphically represents an example method of making an inkjet composition in accordance with the present disclosure;

FIG. 2 graphically represents an example method of reducing curl in accordance with the present disclosure;

FIG. 3 provides example curl data vs. percent ink fill for a base ink formulation in accordance with the present disclosure;

FIG. 4 provides example curl data vs. ink formulations with various organic solvent combinations at various percent ink fills in accordance with the present disclosure;

FIG. 5 provides example curl data vs. ink formulations with various concentrations of diol or triol solvent in accordance with the present disclosure;

FIG. 6 provides example curl vs. ink formulations with various organic solvent combinations in accordance with the present disclosure; and

FIG. 7 provides example curl over time for a printed image using a formulation in accordance with the present disclosure.

### DETAILED DESCRIPTION

Inkjet printing has been popular for home and office printing because of its low cost and overall quality. As printing speeds of inkjet printers increase and advancements in inkjet inks have occurred, these low cost printers are moving into areas where there would be a benefit of higher performance, e.g., high output quality, production of crisp prints on plain paper, etc. During printing, ink can wet cellulose fiber in paper media and disrupt the native intermolecular interactions that impart structural integrity to the paper, particularly plain paper. As the paper dries, the intermolecular interactions tend to become restored as the cellulose fibers shrink, stressing the paper, and leading to noticeable curl. Curl can inhibit proper paper stacking of printed pages and can interfere with post printing processes such as binding or stapling, thereby, interfering with the overall user experience.

In accordance with the present disclosure, an ink composition can include carbon black pigment, polyurethane, at least 50 wt % water, and from 1 wt % to 6 wt % diol solvent, triol solvent, or a mixture thereof. The ink composition can be devoid of 2-pyrrolidone when the diol solvent is present.

In some examples, when present, the diol solvent can include 3-methyl-1,3-butanediol, 2-ethyl-2-hydroxymethyl-1,3-propanediol, 2-methyl-2,4-petanediol, 3-methyl-1,3,5-pentanetriol, ethylhydroxy-propanediol, tri-propylene glycol, triethylene glycol, or a mixture thereof. In other examples, when present, the triol solvent can include 3-methyl-1,3,5-pentanetriol. In one example, the ink composition can further include 1-(2-hydroxyethyl)-2-pyrrolidone. In another example, the ink composition can further include tri-propylene glycol methyl ether, tri-propylene glycol monobutyl ether, tripropylene glycol, triethylene glycol, di-(2-hydroxyethyl)-5,5-di methylhydantoin, or mixtures thereof.

Though any functional range of total organic solvent content can be present, the diol and the triol can be present at the 1 wt % to 6 wt % solvent content, and in one specific example, the total organic solvent content can be from 20 wt % to 30 wt % (which includes the 1 wt % to 6 wt % triol and diol content). Thus, as used herein, “total organic solvent content” refers to the curl reducing diol and/or triol solvent and the co-solvent content and does not include water (as water is otherwise mentioned specifically as an ingredient). Thus, the term “solvent(s)” and “co-solvent(s)” can be used interchangeably and refer generally to organic solvents, not water. In some examples, the ink composition can be devoid of 2-pyrrolidone. In another example, the ink composition can include 60 wt % to 75 wt % water.

In one example, the carbon black pigment can be present in the ink at from 2 wt % to 6 wt % and/or the carbon black pigment can be surface ionized by light, ultraviolet radiation, ozone, or a combination thereof. In another example, the polyurethane can be present in the ink composition from 0.1 wt % to 4 wt % and/or can have a weight average molecular weight from 3,000 Mw to 70,000 Mw, for example. The polyurethane can include polymerized components of an isocyanate, a chain extender leading to a linear polymer or a branched polymer, and a cycloaliphatic or cycloaromatic component. In still another example, the polyurethane to pigment weight ratio can be from 1:10 to 1:2.

A method of making an ink composition can include admixing a carbon black pigment with a polyurethane and a liquid vehicle to form the ink composition. The resulting ink composition can include carbon black pigment, polyurethane, at least 50 wt % water, and from 1 wt % to 6 wt % diol solvent, triol solvent, or a mixture thereof. The ink composition can be devoid of a 2-pyrrolidone when the diol solvent is present. In a further example, the method of making the ink composition can further include a preliminary step of surface treating the carbon black pigment to form a surface ionized carbon black pigment before admixing the carbon black pigment with the liquid vehicle.

A method of reducing curl can include inkjet printing an ink composition onto an uncoated print medium. The ink composition can include carbon black pigment, polyurethane, at least 50 wt % water, and from 1 wt % to 6 wt % diol solvent, triol solvent, or a mixture thereof. The ink composition can be devoid of a 2-pyrrolidone when the diol solvent is present. In one example, the ink composition printed at 27.5% fill on the coated print medium can exhibit less than 1 cm curl after 1 hour. The ink can, of course, can be printed at any fill volume percentage, but at 27.5% fill, an evaluative test with respect the minimization of curl can be conducted.

It is noted that when discussing the various ink compositions and methods described herein, each of these discussions can be considered applicable to the other examples, whether or not they are explicitly discussed in the context of that example. Thus, for example, in discussing a carbon black pigment related to an ink composition such disclosure is also relevant to and directly supported in the context of the methods described herein, and vice versa.

Turning now to the specific ingredients that can be used in the ink composition, as noted, the ink composition can include a carbon black pigment. In one example, the carbon black pigment can be a self-dispersing carbon black pigment, or can be a carbon black pigment that is dispersed by a separate dispersing agent. In another example, the carbon black can be surface treated, such as by light, ultra-violet radiation, or ozone. The surface treatment can result in carbon black pigment with an ionized surface, also referred to herein as “ionized carbon black pigment.” In one example, the surface treatment can be carried out by exposing the carbon black pigment to both light and ozone, resulting in small molecules being generated at the surface of the carbon black.

The carbon black pigment can be present in the ink composition at various concentrations. In one example, the carbon black pigment can be present in the ink at from about 2 wt % to about 6 wt %. In another example, the carbon black pigment can be present at from about 3 wt % to about 5 wt %. In yet another example, the carbon black pigment can be present from about 4 wt % to about 5 wt %.

As mentioned, the inks can also include a polyurethane. The term polyurethane or polyurethane binder includes both more traditional polyurethanes as well as polyureas. The polyurethane can include a double bond, polyurethane-graph polyol, etc. The polyurethane can be a graph polyol, such as Pluracol® (available from BASF). In another example, the polyurethane can include an acrylic functional group. The weight average molecular weight of the polyurethane in the composition can vary. In one example, the polyurethane can have an average molecular weight ranging from about 3,000 Mw to about 70,000 Mw. In yet another example, the average molecular weight of the polyurethane can range from about 15,000 Mw to about 50,000 Mw. In a further example, the polyurethane can have an average molecular weight ranging from about 5,000 Mw to about 25,000 Mw. The polyurethane may have a minimum film-forming temperature from −50° C. to 80° C. In other examples, the polyurethane can have a minimum film-forming temperature from −30° C. to 60° C. or from −25° C. to 50° C.

In some other examples, the polyurethane can include an acrylate-containing or methacrylate-containing monoalcohol bonded to the polymer backbone at one end, and an ionic stabilizing group bonded to the polymer backbone at the other end. The polymer can also or alternatively include an acrylate-containing or methacrylate-containing monoalcohol bonded to both ends of the polymer backbone. In still other examples, the polyurethane can include an ionic stabilizing group bonded to both ends of the polymer backbone. In one example, the polyurethane can include a majority of polymer strands with an acrylate-containing or methacrylate-containing monoalcohol bonded to one end of the polymer backbone and an ionic stabilizing group bonded to the other end of the polymer backbone. Further, any combination of these end groups can be used as may be usable with the inks of the present disclosure.

In other examples, the polyurethane can be more pH-stable when particular types of monomers are included or not included in the polymer backbone and the capping units. In one example, the polymer backbone can be free of ionic stabilizing groups. In particular, the polymer backbone can be devoid of monomers that contain acidic functional groups. In this example, the polyurethane dispersion can include ionic stabilizing groups in the capping units, but not on the polymer backbone. In a specific example, the polymer backbone can be devoid of carboxylate and sulfonate groups.

In still other examples, the polyurethane can be any of a number of polyurethanes that include an isocyanate, and a chain extender leading to either a linear or branched polymer, as well as cycloaliphatic or cycloaromatic components.

As mentioned, the ink compositions can include from about 0.1 wt % to 4 wt % of the polyurethane. In other examples, the compositions can include from about 0.5 wt % to 2 wt % polyurethane, from about 1 wt % to 3 wt, from about 0.1 wt % to about 1.2 wt %, or from 0.1 wt % to 1 wt % polyurethane. In a further example, the ink compositions can be devoid of other binders that are not polyurethane.

The polyurethane to carbon black pigment ratio in the ink compositions can also vary. In one example, the polyurethane to carbon black pigment ratio can range from about 1:10 to about 1:2. In another example, the polyurethane to carbon black pigment ratio can range from about 1:8 to about 1:2. In yet another example, the polyurethane to carbon black pigment ratio can range from about 1:6 to about 1:2. In a further example, the polyurethane to carbon black pigment ratio can range from about 1:5 to about 1:2.

Turning now to the water content in the ink composition, in one example, the composition can include at least 50 wt % water. In another example, the ink composition can include at least 60 wt % water. In yet another example, the ink composition can include at least 65 wt % water. In a further example, ink composition can include from 50 wt % to 80 wt % water, or from 60 wt % to 75 wt % water. In one example, the water can be deionized, purified, or a combination thereof.

In accordance with examples of the present disclosure, a diol and/or triol solvent can be included in the ink composition to reduce curl of a printed medium using the ink composition. The term “solvent” herein refers to both the curl reducing diol and/or triol solvent, as well as other organic solvents that may also be included for other purposes, but excludes water. In one example, the curl reducing diol and/or triol solvent can include 3-methyl-1,3-butanediol, 2-ethyl-2-hydroxymethyl-1,3-propanediol, 2-methyl-2,4-petanediol, 3-methyl-1,3,5-pentanetriol, ethylhydroxy-propanediol, tri-propylene glycol, triethylene glycol, or a mixture thereof. In one specific example, the curl reducing solvent can be or can include 3-methyl-1,3,5-pentanetriol. In another example, the curl reducing solvent can be or can include tripropylene glycol, or can include 2-ethyl-2-hydroxymethyl-1,3-propanediol.

The total organic solvent content can be any organic solvent content that provides acceptable curling properties, but in one specific example, the total organic solvent content can be from 20 wt % to 30 wt % (which includes both the curl reducing diol and/or triol solvent content as well as other organic co-solvent(s) that can also be present). In further detail regarding the diol and/or triol solvent, as mentioned, in one example, the ink composition can include from 1 wt % to 6 wt % of the diol and/or triol solvent plus water and other co-solvent(s). In another example, the diol and/or triol solvent can be present in the ink composition from 1 wt % to 5 wt %, from 2 wt % to 6 wt %, from 2 wt % to 5 wt %, from 3 wt % to 6 wt %, from 3 wt % to 5 wt %, or from 1 wt % to 4 wt %, or from 2 wt % to 4 wt %.

Regarding the balance of the organic solvent content, in addition to the diol and/or triol solvent, the ink compositions can further include other organic compositions that act as co-solvent(s), typically added for other purposes, such as jettability, surface wetting, anti-kogation, improving decap performance, etc. In one example, the co-solvent, which is other than the diol and/or triol solvent, can be present up to about 30 wt %, or in other examples, the co-solvent can be present from 10 wt % to 25 wt %, 14 wt % to 29 wt %, 15 wt % to 25 wt %, or 15 wt % to 20 wt %. In one example, the co-solvent can be 1-(2-hydroxyethyl)-2-pyrrolidone, tri-propylene glycol methyl ether, tri-propylene glycol monobutyl ether, tripropylene glycol, triethylene glycol, di-(2-hydroxyethyl)-5,5-dimethylhydantoin, or a mixture thereof. In another example, the co-solvent can be or can include 1-(2-hydroxyethyl)-2-pyrrolidone.

The ink compositions can further exclude co-solvents that negatively affect curl of a printed medium. In a further example, the ink composition can be devoid of 2-pyrrolidone. However, in one specific example where the curl reducing solvent is a triol solvent, the co-solvent can include 2-pyrrollidone. However, in other examples, even with the use of a triol solvent, the ink can be devoid of 2-pyrrolidone. In some examples, 1-(2-hydroxyethyl)-2-pyrrolidone can be used instead of 2-pyrrolidone with acceptable results.

Consistent with the ink compositions of the present disclosure, various other additives can be employed to enhance properties of the ink composition for specific applications. Examples of these additives can include, but are not limited to, additional polymers, solvents, surfactants, antibacterial agents, UV compositions, sequestering agents, buffers, viscosity modifiers, and/or other additives.

In some examples, the ink compositions can further include a surfactant. In one example, the surfactant can include Surfynol® 104, Surfynol® 440, (both available from Air Products and Chemicals Inc., Pennsylvania), Surfadone™ LP-100 (available from Ashland® Inc., Kentucky), BYK® 3410, BYK® 3400 (both available from BYK® USA Inc. Connecticut), or a combination thereof. The surfactant or combinations of surfactants can be present in the ink composition at from about 0.001 wt % to about 10 wt % and; and in some examples, can be present at from about 0.001 wt % to about 5 wt %. In other examples the surfactant or combinations of surfactants can be present at from about 0.01 wt % to about 3 wt % of the ink composition.

In one example, the surfactant can be a non-ionic surfactant. Some specific examples of the non-ionic surfactant that may be used in the ink composition disclosed herein include acetylene diols, bis-tartrate esters,1,2-hexanediol, mono alcohols, N-alkylpyrrolidinones, and combinations thereof. One example of the acetylene diol is Surfyonol® 104 (Products and Chemicals Inc., Pennsylvania). Examples of suitable bis-tartrate esters include diisoamyl tartrate, dibutyl tartrate, dibenzyl tartrate, and diisopropyl tartrate. Some examples of suitable mono alcohols include lauryl alcohol (i.e., 1-dodecanol), oleyl alcohol (i.e., octadec-9-en-1-ol), stearyl alcohol (i.e., 1-octadecanol), and combinations thereof. Examples of the N-alkylpyrrolidinone are N-octylpyrrolidinone and N-dodecylpyrrolidinone. Some commercially available N-alkylpyrrolidinones include Surfadone™ LP-100 (octylpyrrolidinone) and Surfadone™ LP-300(dodecylpyrrolidinone) (both available from Ashland® Inc., Kentucky). In one example, the non-ionic surfactant that is selected can exclude ethyleneoxy groups.

In one example, an additional component can be those added to inhibit the growth of harmful microorganisms. These additives may be biocides, fungicides, and other microbial agents, which are routinely used in ink formulations. Examples of suitable microbial agents can include, but are not limited to, Acticide® (Thor Specialties Inc., Connecticut), Nuosept™ (Troy Corporation, New Jersey.), Ucarcide™ (Union Carbide Corp., Texas), Vancide® (Vanderbilt Minerals, LLC, Connecticut), Proxel® (Lonza Group Ltd., Maryland), and combinations thereof.

In another example, sequestering agents such as EDTA (ethylene diamine tetra acetic acid) can be included to eliminate the deleterious effects of heavy metal impurities. In yet another example, buffer solutions can be used to control the pH of the ink.

The ink compositions presented herein can reduce curl on a printed image. In order to evaluate curl performance, a medium can be printed at a given area fill and immediately laid flat on a flat surface, such as a countertop or table top. Measurements can be taken from the flat surface to the top of the highest corner of the printed medium. Curl measurements can be taken at varying time points, e.g., from time zero to two weeks, for example, or in other examples at 1 hour, at 2 hours, at 24 hours, at 48 hours, etc. These measurements indicate the extent of curl.

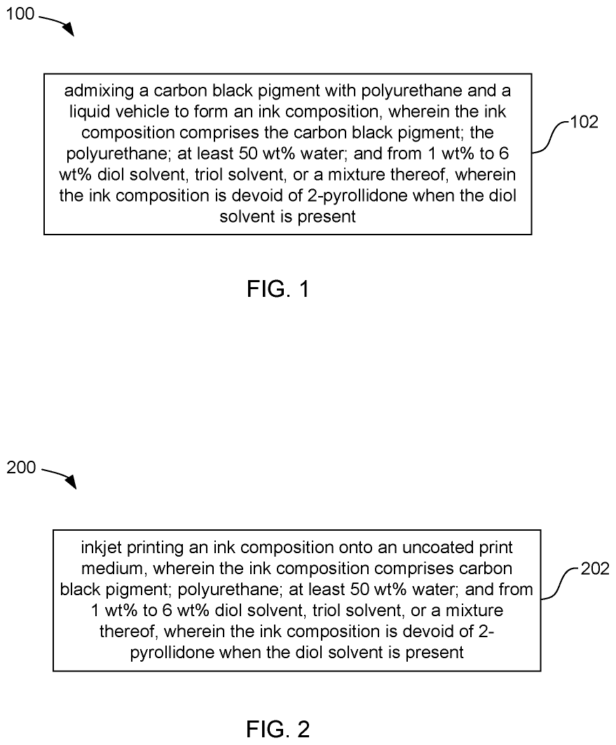

Turning now to the figures, a method of making an ink composition 100 is shown in FIG. 1. The method can include admixing 102 a carbon black pigment with polyurethane and a liquid vehicle to form an ink composition, wherein the ink composition can include the carbon black pigment; the polyurethane; at least 50 wt % water; and from 1 wt % to 6 wt % diol solvent, triol solvent, or a mixture thereof. When the diol solvent is present, the ink composition can be devoid of 2-pyrrolidone In one example, the method can include a preliminary step of surface treating the carbon black pigment to form a surface ionized carbon black pigment for admixing with the liquid vehicle. Any of other compositional parameters and/or steps described herein can also be applicable to this method.

In another example, as shown in FIG. 2, is method of reducing curl 200 can include inkjet printing 202 an ink composition onto an uncoated print medium. The ink composition can include carbon black pigment; polyurethane; at least 50 wt % water; and from 1 wt % to 6 wt % diol solvent, triol solvent, or a mixture thereof. The ink composition can be devoid of 2-pyrrolidone when the diol solvent is present. Again, any of other compositional parameters and/or steps described herein can also be applicable to this method.

In one specific example, the ink composition can be printed at 27.5% fill on the uncoated print medium can exhibit less than 1 cm curl after 1 hour. In other examples, the medium can exhibit less than 3 cm of curl, less than 2.5 cm of curl, less than 2 cm of curl, less than 1 cm of curl, or from 0 cm to 1 cm of curl after 1 hour. The reduction in curl can be a reduction in short term curl (a few hours) and/or a reduction in long term curl (2 weeks or more). For example, at least 2 weeks after printing, the curl can be 3 cm or less, 2.5 cm or less, 2 cm or less, 1.5 cm or less, 1 cm or less, or 0 cm. In other example, a reduction in curl can be determined by comparing the ink composition to a standard ink composition having the same components except that the diol solvent, triol solvent, or mixture thereof is replaced by an equivalent amount (proportionally if more than one co-solvent present) of the balance of the other co-solvents.

It is noted that, as used in this specification and the appended claims, the singular forms “a,” “an,” and “the” include plural referents unless the content clearly dictates otherwise.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, “curl reducing solvent” refers to a diol solvent, a triol solvent, or a mixture thereof. These solvents have 2 or 3 free hydroxyl groups. Notably, the presence of excess hydroxyl groups (greater than 3), or too few hydroxyl groups (0 or 1), did not provide the same reduction in curl as compared to the use of solvents with 2 or 3 free hydroxyl groups. The reduction in curl was found to be particularly useful in the presence of polyurethane type binders. The general term “solvent” includes any organic solvent, including the diol and/or triol curl reducing solvent(s), and other co-solvents that may be present in the ink composition, and does not include water, as water is described separately.

“Media,” “medium,” or “print medium,” includes any base material that is suitable for printing. In one example, the medium can be plain paper or uncoated paper that can be particularly susceptible to curl.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight ratio range of about 1 wt % to about 20 wt % should be interpreted to include not only the explicitly recited limits of about 1 wt % and about 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following examples illustrate the technology of the present disclosure. However, it is to be understood that the following is only exemplary or illustrative of the application of the principles of the presented formulations and methods. Numerous modifications and alternative methods may be devised by those skilled in the art without departing from the present disclosure. The appended claims are intended to cover such modifications and arrangements. Thus, while the technology has been described above with particularity, the following provide further detail in connection with what are presently deemed to be the acceptable examples.

### Example 1

### Testing Protocol

In all of the Examples, a base ink formulation known to exhibit unacceptable plain paper curl was modified with various types of solvents and printed onto a medium in order to evaluate curl performance. The various ink formulations were filled into HP® 940 cartridges and printed using an HP® Officejet® Pro 8000 inkjet printer (both available from available from Hewlett-Packard, Co., California). The medium used was Georgia-Pacific Spectrum® Standard 92 Multi-Purpose Paper (available from Georgia-Pacific, LLC Kansas). An estimate of 10 ng/drop was assumed for the testing. The printed images were printed within 3 mm from the edge of the paper to maximize ink flux and the curl defect. The observed curl was measured in cm at various times from a flat surface to the height of the largest curl defect exhibited by the paper medium. This methodology is utilized in all of the Examples.

### Example 2

### Curl Based on Percent Ink Fill

In this example, the Base Ink Formulation was printed at a variety of percent ink fills from 25% to 100% (40-160 ng/300^{th} of an inch). The curl of the printed media was measured 1 hour after printing. The solvents in the Base Ink Formulation included a total organic solvent content of 24 wt % with no diol or triol solvent present. Table 1 below provides the general formulation for the Base Ink Formulation in all of the Examples unless indicated otherwise.

TABLE 1
Base Ink Formulation

| Component | Wt % |
|---|---|
| 2-pyrrolidone | 8 |
| 1-(2-hydroxyethyl)-2-pyrrolidone | 16 |
| Surfactant | 0.1 |
| Biocide | 0.27 |
| Polyurethane Binder | 1.7 |
| Pigment | 4.4 |
| Water | 69.53 |

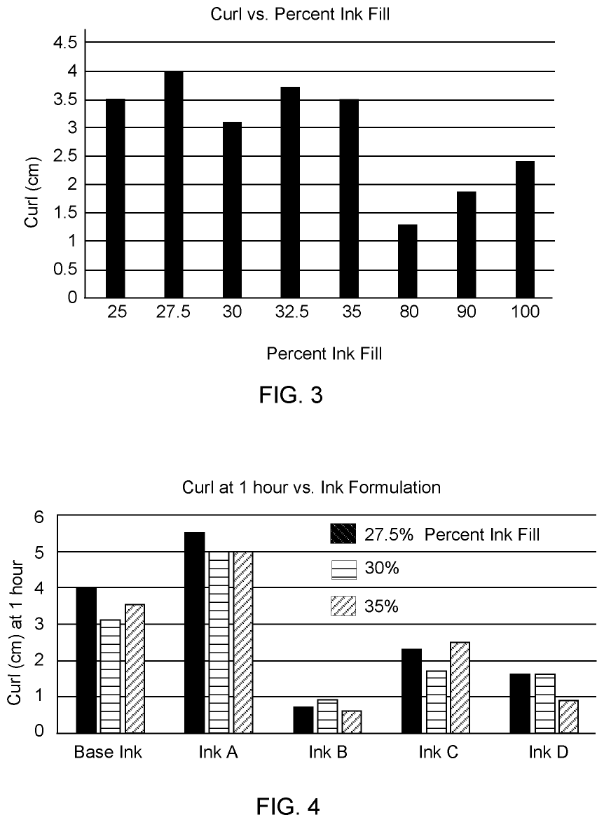

The ink fill and curl data generated using the Base Ink Formulation of Table 1 is shown in Table 2 below, and in FIG. 3.

TABLE 2
Ink Fill and Observed Curl

| | | |
|---|---|---|
| Ink Fill | Drop Weight | Observed Curl (cm) |

| | | | |
|---|---|---|---|
| 25% | 40 | ng/300^{th} | 3.5 |
| 27.5% | 44 | ng/300^{th} | 4 |
| 30% | 48 | ng/300^{th} | 3.1 |
| 32.5% | 52 | ng/300^{th} | 3.7 |
| 35% | 56 | ng/300^{th} | 3.5 |
| 80% | 128 | ng/300th | 1.3 |
| 90% | 144 | ng/300^{th} | 1.8 |
| 100% | 160 | ng/300^{th} | 2.4 |

As can be seen in Table 2 and FIG. 3, the printed media exhibited the most curl generally within the range from 25% to 35% fill (40 ng/300^{th} of an inch to 56 ng/300^{th} of an inch). Accordingly, this fill percent range was chosen as the focus for the remainder of the examples.

### Example 3

### Inclusion of 5 wt % Diol or Triol Solvent vs. Curl

Various diol or triol solvents were formulated at 5 wt % with one of the solvents used in the Base Ink Formulation of Table 1. The total organic solvent concentration in all of the ink formulations was maintained at 24 wt %, e.g., 5 wt % of the diol or triol solvent and 19 wt % of one of the other solvents was also included. The other ink ingredients listed in Table 1 were the same. The organic solvent content for each solvent in the various formulations are shown in Table 3, as follows:

TABLE 3
Modified Formulations

| Ink Formulation | Total Organic Solvent |
|---|---|
| Base Ink | 1-(2-hydroxyethyl)-2-pyrrolidone (16 wt %) |
| | 2-pyrrolidone (8 wt %) |
| Ink A | 2-pyrrolidone (19 wt %) |
| | 2-ethyl-1,3-hexanediol (5 wt %) |
| Ink B | 1-(2-hydroxyethyl)-2-pyrrolidone (19 wt %) |
| | 3-methyl-1,3,5-pentanetriol (5 wt %) |
| Ink C | 1-(2-hydroxyethyl)-2-pyrrolidone (19 wt %) |
| | 2-ethyl-2-hydroxymethyl-1,3-propanediol (5 wt %) |
| Ink D | 1-(2-hydroxyethyl)-2-pyrrolidone (19 wt %) |
| | tripropylene glycol (5 wt %) |

The Base Formulation and Inks A-D were tested to measure curl at 1 hour for three different fill areas (27.5%, 30%, and 35%). The curl of the printed media one hour after printing for each of the fill areas was observed, and is shown in Table 4 and FIG. 4.

TABLE 4
Curl at 1 hour vs. Ink Formulation

| | Area Fill and Curl (cm) at 1 hour | | |
|---|---|---|---|
| Ink Formulation | 27.5% | 30% | 35% |
| Base Ink | 4 | 3.1 | 3.5 |
| Ink A | 5.5 | 5 | 5 |
| Ink B | 0.7 | 0.9 | 0.6 |
| Ink C | 2.3 | 1.7 | 2.5 |
| Ink D | 1.6 | 1.6 | 0.9 |

As can be seen in FIG. 4 and Table 4, incorporating 5 wt % of 3-methyl-1,3,5-pentanetriol into the ink formulation produced a print having the least amount of curl at 1 hour. Incorporating 5 wt % of 2-ethyl-1,3-hexanediol with 19 wt % 2-pyrrolidone as an organic solvent vehicle in the ink formulation produced a print having an increased amount of curl at 1 hour when compared to the curl of a printed medium produced using the Base Ink Formulation. However, this can be attributable to the presence of 2-pyrrolidone, which has been found to be a poor solvent with respect to curl reduction unless a stronger curl reducing solvent is also present, e.g., 3-methyl-1,3,5-pentanetriol. In addition, incorporating 5 wt % of 2-ethyl-2-hydroxymethyl-1,3-propanediol or tripropylene glycol as a solvent into the ink formulation produced a printed image that exhibited a reduced amount of curl at 1 hour when compared to the curl of a printed medium produced using the Base Ink Formulation.

This example demonstrates that incorporating 5 wt % of 3-methyl-1,3,5-pentanetriol, 2-ethyl-2-hydroxymethyl-1,3-propanediol, or tripropylene glycol as a solvent in an ink formulation can reduce the amount of curl exhibited by a printed medium 1 hour after printing.

### Example 4

### Effect of Diol or Triol Solvent Concentrations with Various Polyurethane Binders vs. Curl

The effect of the amount of diol or triol solvent in the formulation was evaluated to determine if increasing the concentration of the diol or triol solvent exhibited any added benefit to reducing the amount of curl of a printed image. In addition, various polyurethanes were tested to verify that a general improvement in curl reduction can occur when adding the solvents of the present disclosure to the inks that contain various types of polyurethane. In other words, curl reduction provided by these added solvents can be generated with any of a number of types of polyurethanes and modified polyurethanes. The polyurethanes used were different varieties of polyurethanes that each included an isocyanate, a chain extender leading to either a linear or branched polymer, as well as cycloaliphatic or cycloaromatic components.

The base ink formulation used in this Example is shown in Table 5 below. The total organic solvent content was maintained at 24 wt % and the polyurethane binder was established at 3 wt % in all of the formulations.

TABLE 5
Base Ink Formulation

| Component | Wt % |
|---|---|
| Total Organic Solvent | 24 |
| Surfactant | 0.1 |
| Biocide | 0.27 |
| Polyurethane Binder | 3.0 |
| Pigment | 4.4 |
| Water | 68.23 |

Ink Formulations F-H and F*-H* incorporated 1-(2-hydroxyethyl)-2-pyrollidone with 3-methyl-1,3,5, pentanetriol as organic solvents with the 3-methyl-1,3,5, pentanetriol at either 5 wt % or 13 wt %. Each of the ink pairings, e.g., Inks F and F*, Inks G and G*, and Inks H and H* incorporated a different version of the polyurethane compared to the other ink pairings. This was done to determine if solvent selection can provide improvement, even when using different versions of polyurethane.

TABLE 6
Modified Formulations

| Ink Formulation | Total Organic Solvent |
|---|---|
| Ink F | 1-(2-hydroxyethyl)-2-pyrrolidone (19 wt %) |
| | 3-methyl-1,3,5-pentanetriol (5 wt %) |
| Ink F* | 1-(2-hydroxyethyl)-2-pyrrolidone (11 wt %) |
| | 3-methyl-1,3,5-pentanetriol (13 wt %) |
| Ink G | 1-(2-hydroxyethyl)-2-pyrrolidone (19 wt %) |
| | 3-methyl-1,3,5-pentanetriol (5 wt %) |
| Ink G* | 1-(2-hydroxyethyl)-2-pyrrolidone (11 wt %) |
| | 3-methyl-1,3,5-pentanetriol (13 wt %) |
| Ink H | 1-(2-hydroxyethyl)-2-pyrrolidone (19 wt %) |
| | 3-methyl-1,3,5-pentanetriol (5 wt %) |
| Ink H* | 1-(2-hydroxyethyl)-2-pyrrolidone (11 wt %) |
| | 3-methyl-1,3,5-pentanetriol (13 wt %) |

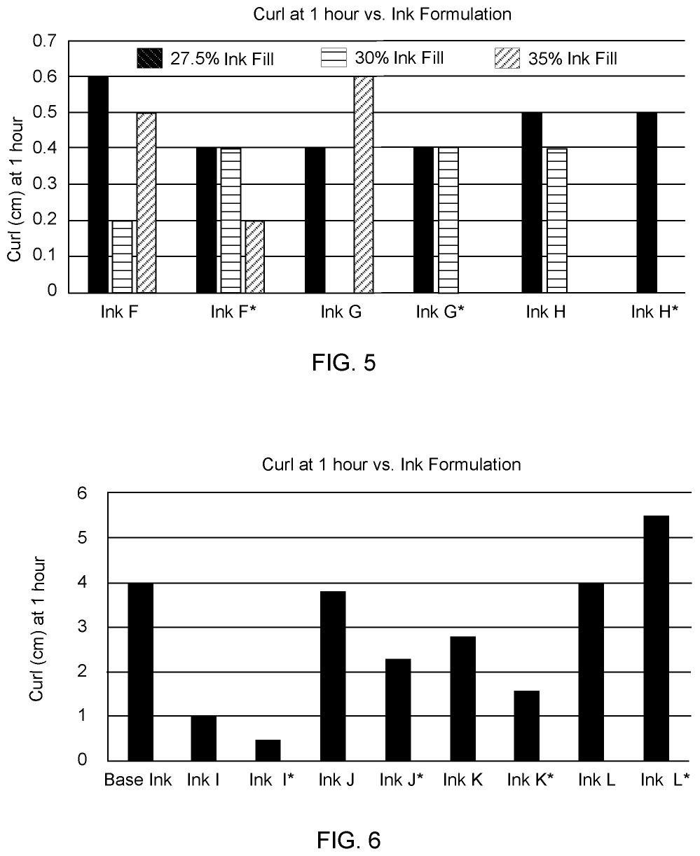

These inks were printed at 27.5% fill, 30% fill, and 35% fill. The diol or triol solvent, concentration, and curl at 1 hour for each of these fill volume percentages are shown in Table 7 and in FIG. 5.

TABLE 7
Effect of Different Levels of Solvent and
Different Polyurethane Binders on Curl

| | Amount | | | | |
|---|---|---|---|---|---|
| | of Diol | | | | |
| Ink | or Triol | Polyure- | Curl (cm) at 1 hr | | |
| Formu- | Solvent | thane | 27.5% Fill | 30% Fill | 35% Fill |
| lation | (wt %) | Binder | 44 ng/300^{th} | 48 ng/300th | 56 ng/300th |
| Ink F | 5 | Version 1 | 0.6 | 0.2 | 0.5 |
| Ink F* | 13 | Version 1 | 0.4 | 0.4 | 0.2 |
| Ink G | 5 | Version 2 | 0.4 | 0 | 0.6 |
| Ink G* | 13 | Version 2 | 0.4 | 0.4 | 0 |
| Ink H | 5 | Version 3 | 0.5 | 0.4 | 0 |
| Ink H* | 13 | Version 3 | 0.5 | 0 | 0 |

As can be seen in the table above, increasing the amount of diol or triol solvent from 5 wt % to 13 wt % generally did not exhibit any significant benefit with respect to curl. In some case a minimal improvements occurred while in other cases curl increased. Thus, a trend could not be established based on whether or not increasing the diol or triol solvent from 5 wt % to greater than 10 wt % was useful with respect to curl. However, these diol and triol solvents tend to reduce durability when they are included at too great of a concentration, and thus, a good balance between improving curl and yet retaining durability can be found within the range of 1 wt % to 6 wt % of the diol and/or triol solvent. Furthermore, increasing the diol or triol solvent to concentrations greater than 8% resulted in diminishing nozzle health and a reduction in overall reproducibility which was reflected in the printed media.

Based on the testing above, it was determined that the type of polyurethane binder can have some effect on the curl reduction of the printed media. However, regardless of the variation in the polyurethane binder, the results showed that curl reduction can be generally improved by incorporating the solvent packages presented herein with any of the polyurethane binders.

### Example 5

### Effect of 2-Pryollidone on Curl

The effect of 2-pyrrolidone as a co-solvent in ink formulations of the present disclosure was evaluated with respect to its effect on curl of a printed medium. Inks I-L incorporated various organic solvent systems including both 2-pyrrolidone and 1-(2-hydroxyethyl)-2-pyrrolidone, along with the diol or triol solvent. In Ink 1*-K*, the 2-pyrrolidone was replaced with an equivalent amount of the 1-(2-hydroxyethyl)-2-pyrrolidone. In Ink L*, rather than replacing 2-pyrrolidone with 1-(2-5 hydroxyethyl)-2-pyrrolidone, 1-(2-hydroxyethyl)-2-pyrrolidone was replaced with 2-pyrrolidone. For each of these inks, the curl at 1 hour is shown in Table 8 below and in FIG. 6.

TABLE 8
Effect of 2-Pyrrolidone as a Co-Solvent on Curl

| | | Curl (cm) |
|---|---|---|
| | | at 1 hr |
| Ink | | 27.5% Fill |
| Formulation | Total Organic Solvent | 44 ng/300th |
| Base Ink | 1-(2-hydroxyethyl)-2-pyrrolidone (16 wt %) | 4 |
| | 2-pyrrolidone (8 wt %) | |
| Ink I | 1-(2-hydroxyethyl)-2-pyrrolidone (11 wt %) | 1 |
| | 2-pyrrolidone (8 wt %) | |
| | 3-methyl-1,3,5-pentanetriol (5 wt %) | |
| Ink I* | 1-(2-hydroxyethyl)-2-pyrrolidone (19 wt %) | 0.5 |
| | 3-methyl-1,3,5-pentanetriol (5 wt %) | |
| Ink J | 1-(2-hydroxyethyl)-2-pyrrolidone (11 wt %) | 3.8 |
| | 2-pyrrolidone (8 wt %) | |
| | 2-ethyl-2-hydroxymethyl-1,3-propanediol | |
| | (5 wt %) | |
| Ink J* | 1-(2-hydroxyethyl)-2-pyrrolidone (19 wt %) | 2.3 |
| | 2-ethyl-2-hydroxymethyl-1,3-propanediol | |
| | (5 wt %) | |
| Ink K | 1-(2-hydroxyethyl)-2-pyrrolidone (11 wt %) | 2.8 |
| | 2-pyrrolidone (8 wt %) | |
| | 3-methyl-1,3-butanediol (5 wt %) | |
| Ink K* | 1-(2-hydroxyethyl)-2-pyrrolidone (19 wt %) | 1.6 |
| | 3-methyl-1,3-butanediol (5 wt %) | |
| Ink L | 1-(2-hydroxyethyl)-2-pyrrolidone (11 wt %) | 4 |
| | 2-pyrrolidone (8 wt %) | |
| | 2-ethyl-1,3-hexanediol (5 wt %) | |
| Ink L* | 2-pyrrolidone (19 wt %) | 5.5 |
| | 2-ethyl-1,3-hexanediol (5 wt %) | |

Formulations incorporating 2-pyrrolidone in the total organic content produced a printed medium that exhibited worse curl than formulations that had 2-pyrrolidone replaced in the total organic solvent with an equivalent amount of 1-(2-hydroxyethyl)-2-pyrrolidone. In some instances, the reduction in curl was as great as 50%. On the contrary, when 1-(2-hydroxyethyl)-2-pyrrolidone was replaced with 2-pyrrolidone, as shown in Ink L*, the resultant print medium exhibited more curl. This example demonstrates that the inclusion of 2-pyrrolidone as a co-solvent in the organic solvent system can increase the curl on a printed medium. Notably, the 2-pyrrolidone in the presence of the triol (3-methyl-1,3,5-pentanetriol), as shown in Ink I, had an acceptable curl prior to removal of the 2-pyrrolidone (1 cm). Even so, removal of the 2-pyrrolidone caused the curl to be reduced still further in Ink I*. Thus, 2-pyrrolidone can be included in the ink formulations of the present disclosure when the curl reducing solvent is a triol, for example.

### Example 6

### Curl of a Printed Image Over Time

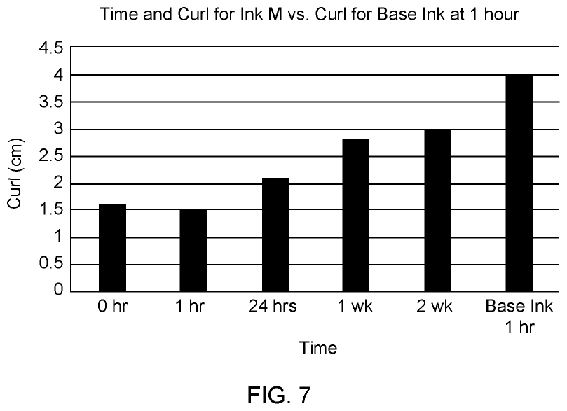

The curl of a printed medium can change over time, accordingly, Formulation K* (see Table 6 above) was printed onto a medium and evaluated for the curl over the course of 2 weeks. This data is shown in Table 9 below and in FIG. 7.

TABLE 9
Curl Over Time

| | Curl (cm) |
|---|---|
| Time | 27.5% Fill |
| Initial - 0 | 1.6 |

| | | |
|---|---|---|
| 1 | hour | 1.5 |
| 24 | hours | 2.1 |
| 1 | week | 2.8 |
| 2 | weeks | 3 |

As can be seen, the formulation resulted in a printed medium that gradually increased in curl. However, the extent of the curl on the printed image after 2 weeks was still less than the curl of a printed image using the Base Ink Formulation at 1 hour after printing. The Base Ink Formulation provided a printed image having a curl of 4 cm after 1 hour, see Tables 2, 4, and 6. The curl at 2 weeks for the Base Ink Formulation was immeasurable, as, the printed image had completely rolled up forming a scroll-like tube. Therefore, the diol and/or triol solvents described herein maintain an anti-curl effect over time.

While the present technology has been described with reference to certain examples, those skilled in the art will appreciate that various modifications, changes, omissions, and substitutions can be made without departing from the disclosure. It is intended, therefore, that the disclosure be limited only by the scope of the following claims.

What is claimed is:

1. An ink composition, comprising:
carbon black pigment;
polyurethane;
at least 50 wt % water; and
from 1 wt % to 6 wt % diol solvent, triol solvent, or a mixture thereof, wherein the ink composition is devoid of 2-pyrrolidone when the diol solvent is present.

2. The ink composition of claim 1, wherein the diol solvent is present and comprises 3-methyl-1,3-butanediol, 2-ethyl-2-hydroxymethyl-1,3-propanediol, 2-methyl-2,4-petanediol, 3-methyl-1,3,5-pentanetriol, ethylhydroxy-propanediol, tri-propylene glycol, triethylene glycol, or a mixture thereof.

3. The ink composition of claim 1, wherein the triol solvent is present and comprises 3-methyl-1,3,5-pentanetriol.

4. The ink composition of claim 1, further comprising 1-(2-hydroxyethyl)-2-pyrrolidone.

5. The ink composition of claim 1, further comprising tri-propylene glycol methyl ether, tri-propylene glycol monobutyl ether, tripropylene glycol, triethylene glycol, di-(2-hydoxyethyl)-5,5-dimethylhydantoin, or a mixture thereof.

6. The ink composition of claim 1, wherein the ink composition has a total organic solvent content from 20 wt % to 30 wt %.

7. The ink composition of claim 1, wherein the ink composition is devoid of 2-pyrrolidone.

8. The ink composition of claim 1, wherein the polyurethane comprises polymerized components of an isocyanate, a chain extender leading to a linear polymer or a branched polymer, and a cycloaliphatic or cycloaromatic component.

9. The ink composition of claim 1, wherein the polyurethane is present at from 0.1 wt % to 4 wt % has a weight average molecular weight ranging from 3,000 Mw to 70,000 Mw.

10. The ink composition of claim 1, wherein the carbon black pigment is present at from 2 wt % to 6 wt % and is surface ionized by light, ultraviolet radiation, ozone, ora combination thereof.

11. The ink composition of claim 1, wherein the polyurethane to pigment ratio ranges from 1:10 to 1:2.

12. A method of making an ink composition, comprising admixing a carbon black pigment with a polyurethane and a liquid vehicle to form an ink composition, wherein the ink composition comprises:
the carbon black pigment,
the polyurethane,
at least 50 wt % water, and
from 1 wt % to 6 wt % diol solvent, triol solvent, or a mixture thereof, wherein the ink composition is devoid of 2-pyrrolidone when the diol solvent is present.

13. The method of claim 12, further comprising a preliminary step of surface treating the carbon black pigment to form a surface ionized carbon black pigment for admixing with the liquid vehicle.

14. A method of reducing curl, comprising inkjet printing an ink composition onto an uncoated print medium, wherein the ink composition comprises:
carbon black pigment;
polyurethane;
at least 50 wt % water; and
from 1 wt % to 6 wt % diol solvent, triol solvent, or a mixture thereof, wherein the ink composition is devoid of 2-pyrrolidone when the diol solvent is present.

15. The method of claim 14, wherein the ink composition printed at 27.5% fill on the uncoated print medium exhibits less than 1 cm curl after 1 hour.
